(19) United States
(12) Patent Application Publication
(10) Pub. No.: US 2004/0202188 A1
(43) Pub. Date: Oct. 14, 2004

(54) IP voice packet network voice system

(75) Inventors: Erh-Jen Hou, Taipei (TW); Wen-Cheng Liu, Taipei (TW); Er-Ta Ma, Taipei (TW); Ming-Shun Hsiao, Taipei (TW); Chun-Wei Lien, Taipei (TW)

Correspondence Address: BACON & THOMAS, PLLC, 625 SLATERS LANE, FOURTH FLOOR, ALEXANDRIA, VA, 22314

(73) Assignee: CaManGi Corporation, Taipei (TW)

(21) Appl. No.: 10/412,393

(22) Filed: Apr. 14, 2003

(51) Int. Cl. H04L 12/56

(52) U.S. Cl. 370/401

(57) ABSTRACT

The invention herein relates to an IP (internet protocol) voice packet network voice system, wherein a plurality of IP servers is capable of data sharing, mutual support and compatible to a variety of medium servers. Said voice packet is transmitted in the point to point internet mode to individual voice terminals where a plurality of (internet) add-on medium servers will provide specific function in accordance with the voice packet.

### BACKGROUND OF THE INVENTION

1) Field of the Invention

The invention herein relates to an IP (internet protocol) voice packet network voice system, specifically to a variety of add-on services to the convenience of internet phone users.

2) Description o the Prior Art

The coming of services internet age inspired large demands of add-on network on the internet. Many a network telephone concepts were conceived in the early stage of internet development. Internet phone is such a network telephone from early time, though it is only recent technology in voice compression and improved bandwidth made it possible for many of these voice packet add-on services, hence the popularity of internet phone.

The development of internet phone and the added-on service packets has been disadvantaged by the technical bottleneck of voice compression and internet bandwidth restriction for as long as they have been the market focus. The bulk of conventional internet phone products are still marred by the transmission speed, bandwidth and voice signal delay issue.

### SUMMARY OF THE INVENTION

The present invention herein undertake the new approaches where IP server and voice terminals communicate by UDP (user datagram protocol), simulating a TCP (Transmission control protocol) transmission, using a NAT (network address translation) environment to overcome the major deficiencies.

Specifically, the invention herein consists of a plurality of IP (Internet Protocol) servers managed by a web page control interface, wherein the servers are capable of system back up and restoration function. Individual voice terminals register data of various mediums onto IP (Internet Protocol) servers through the network. Voice packets reach individual voice terminals via the internet point to point mode where internet voice add-on service servers process and provide the add-on services to the individual voice terminal.

### BRIEF DESCRIPTION OF THE DRAWINGS

FIG. 1 is a structural diagram of the IP server of the invention herein.

FIG. 2 is a conceptual diagram of the individual voice terminals and the IP voice packet internet voice system of the invention herein.

FIG. 3 is a block diagram of the individual voice terminals transmitting voice packets of the invention herein.

FIG. 4 is a conceptual drawing showing the individual voice terminals depositing received voice packets in the ring buffer zone of the invention herein.

### DETAILED DESCRIPTION OF THE PREFERRED EMBODIMENT

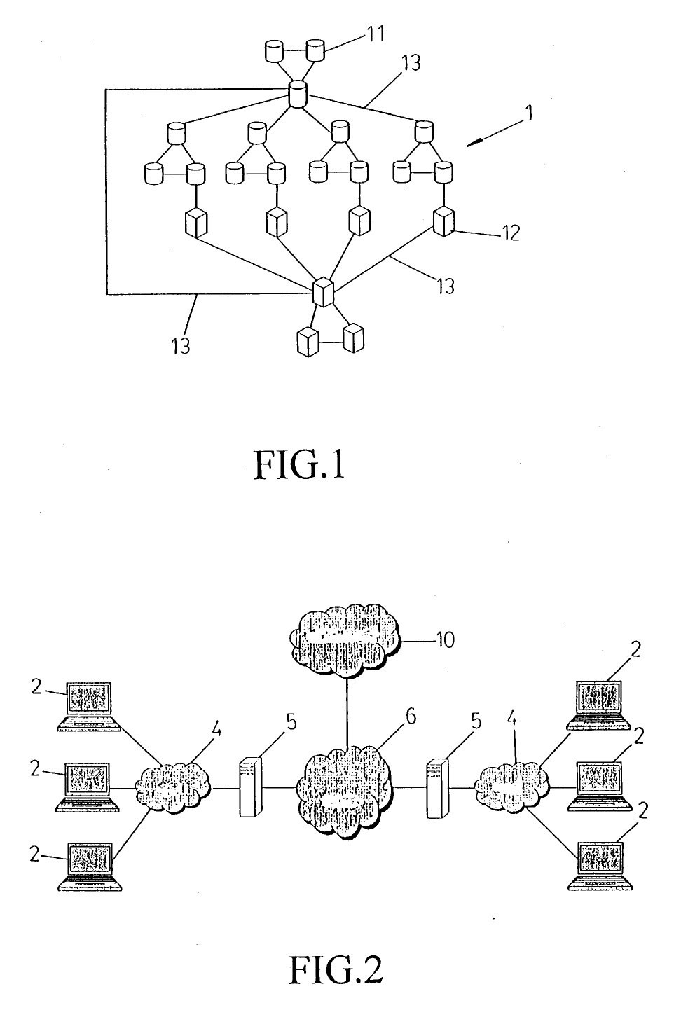

Referring to FIGS. 1 and 2, structural and conceptual diagrams of the preferred embodiment of the present invention having an internet comprises of one or a plurality of IP (internet protocol) server (1), one or a plurality of individual voice terminals (2) and internet voice added-on service servers (3), of which:

The IP server (1) is itself an internet network, constituted by a plurality of database management systems (11), a plurality of internet protocol servers (12) connected through system linkage (13), as illustrated in FIG. 1. Said internet protocol servers (12) locate and access individual voice terminal (2) data through the data base management system (11) and direct the data to designated individual voice terminal (2). Data base management system (11) and IP system (12) both back up and register in the central data base management system and the central IP system. In other words, the IP Server (1) performs as a main server of the entire IP voice packet network voice system (10), processes both back up and registration with the central database management system and the central IP system, wherein the central database management system and the central IP both have their own back up auxiliary system so that when said internet voice packet network voice system malfunctions, it will undergo automatic switching and make adjustments.

The IP server (1) communicates with individual voice terminal (2) in UDP (user datagrame protocol) while system information is being delivered, the communication mode changes to an imitating TCP (transmission control protocol) to increase individual messages transmission speed and to assure its arrival.

The Individual voice terminal (2) covers a wide range of mediums that include compact disc, plug-in memory unit, wireless module devices (such as Bluetooth, Infrared, and etcetera), hand-held radio device or ear phone-microphone device, such as shown in FIG. 2 where a plurality of voice terminals (2) are located under a network address translation (NAT, 5) network environment through a local area network (LAN, 4) whereby exploiting the signal transmission delay nature of the network address translation (NAT, 5) to complete a point to point transmission ; further on to complete the IP voice packet network voice system (10) service through internet (6).

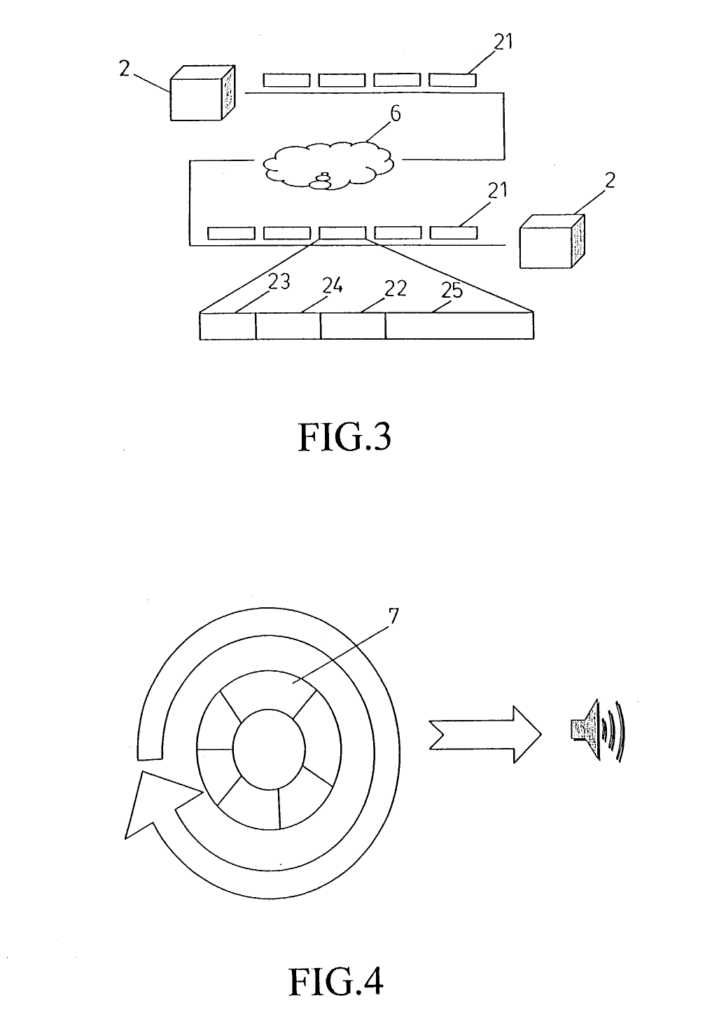

Referring to FIG. 3 wherein the voice terminal (2) delivers the voice data Packet (21) through internet (6) by means of pre-fixing the packets with packet serial number (22), IP (internet protocol) label (23), UDP (user datagrame protocol) (24), and voice signal (25) and etcetera; where upon receiving the voice data packet (21) the designated voice terminal (2) is to adjust the broadcasting timing in accordance with the timing prefix of the voice data packet such as to eliminate the voice signal delay effect on the user.

The Individual voice terminal (2) can choose “Network identification code” via mouse, web page or software program to directly dial the designated individual terminal, individual voice terminal (2) can also connect an input device, dialing a function key to reach pre-set individual network identification code. The network identification code can be names, nick names, company titles, phone numbers, e-mail addresses and etcetera, said network identification code can also be stored in it's own variety of mediums (such as compact disc, etc.) to allow the individual voice terminal (2) user to read his/hers own network identification code.

Referring to FIGS. 3 and 4 where individual voice terminal (2) processes each received voice data packet by means of storing said voice data packet (21) in the ring buffer zone (7) and record arrival time for each voice data packet (21) whereby to adjust the broadcast timing/speed of the voice data packets.

Also when the voice terminal (2) dial a designated terminal by means of network identification code e-mail address while the designated terminal does not have the add-on service, it can notify the designated terminal via e-mail through the network voice add-on service server (3) to download individual voice terminal service software. When the individual voice terminal (2) adapts compact disc as a medium to place it in a CD-ROM, it automatically initiates individual voice terminal software to execute the data registration onto the IP server (1) and reaches the IP voice packet network voice system (10) user.

1. An IP (internet protocol) voice packet network voice system, comprises of:
one or a plurality of IP servers, all sharing data, resources and providing mutual supports, a web page control interface to manage the IP servers with provision of system back up and restoration capacity;
An individual voice terminal, whereby a variety of medium, to register data onto the IP server and where the transmission of voice is processed on a voice device then through the internet in the point to point mode to the designated voice terminal:
one or plurality of network voice add-on service servers thereby to provide individual voice network add-on voice services, such as network voice mail box, directory, audio-visual data download and etcetera.

2. An IP (internet protocol) voice packet network voice system of claim 1, wherein the IP server consists of: a data base management system and a IP system; the IP system in charge of locating and accessing individual voice terminal transmission data then forwarding to designated individual voice terminal system; the data base management system and the IP system process data back up and registration with both the central data base management and central IP system.

3. An IP voice packet network voice system of claim 1,
wherein all IP servers are provided with back up system, having the central database management system and the central IP system as main server for central management and backing up of the entire network voice system wherein the central data base management and central IP system are both with own back up auxiliary system so that the system undergoes automatic switching and adjustment when network voice system experiencing abnormity.

4. An IP (internet protocol) voice packet network voice system of claim 1, wherein, the IP server and individual voice terminal exchange data in the UDT (user datagrame protocol) mode while the IP (internet protocol) server and the entire voice terminal communicate in simulated TCP (transmission control protocol) mode to increase the transmission speed and assure its arrival.

5. An IP (internet protocol) voice packet network voice system of claim 1, wherein the individual voice terminals uses a variety of mediums such as: compact disc, plug-in memory unit, wireless module device (such as Bluetooth, infrared and etcetera), hand held radio device or ear phone microphone device.

6. An IP (internet protocol) voice packet network voice system of claim 1, wherein the voice point to point transmission to the voice terminal under NAT (network address translation) network environment are processed in a way to exploit the signal transmission delay of the NAT environment.

7. An IP (internet protocol) voice packet network voice system of claim 1, wherein prefixes are made related to packet serial order when voice packets are transmitted from individual voice terminals, where at the receiving end adjustment are made upon broadcasting the voice data such that the user will not sense a signal delay in the transmission.

8. An IP (internet protocol) voice packet network voice system of claim 1, wherein an individual voice terminal user can select a network identification code by using a mouse on the web page or software program, dialing directly to a designated voice terminal, users can also use an individual voice terminal to connect to an input device, calling a pre-set individual network identification code via a pre-set function key.

9. An IP (internet protocol) voice packet network voice system of claim 8, wherein, a network identification code can be names, nick names, company titles, telephone numbers and e-mail addresses; such network identification code can be stored in various medium used by the individual voice terminals for the users to read.

10. An IP (internet protocol) voice packet network voice system of claim 1, wherein the individual voice terminals process voice data packets by storing the voice data packets arriving time in a ring buffer zone so as to adjust the voice data packets broadcasting speed accordingly.

11. An IP (internet protocol) voice packet network voice system of claim 1, wherein when an individual voice terminal calls another voice terminal by network identification code/e-mail address while the other individual voice terminal is not provided with the service thereof, the individual voice terminal can send e-mail to the other individual voice terminal through the network voice add-on service server, notify the opposite party to download the individual voice terminal software.

12. An IP (internet protocol) voice packet network voice system of claim 5, Wherein, when the application medium is a compact disc, placing the compact disc in CD-ROM thereby automatically initiate the individual voice terminal software to execute registration data to IP server and render the network voice system service.
